(19) United States
(12) Patent Application Publication
(10) Pub. No.: US 2006/0179995 A1
(43) Pub. Date: Aug. 17, 2006

(54) Image cutter for producing stereo relief image

(76) Inventors: Faye Angevine, Taipei (TW); Yeqing Deng, Dongguan City (CN)

Correspondence Address: MORRISS O'BRYANT COMPAGNI, P.C., 136 SOUTH MAIN STREET, SUITE 700, SALT LAKE CITY, UT, 84101, US

(21) Appl. No.: 11/259,798

(22) Filed: Oct. 27, 2005

(30) Foreign Application Priority Data
Oct. 28, 2004 (CN) 200420094410.9

(51) Int. Cl. B26B 3/00

(52) U.S. Cl. 83/686; 30/315

(57) ABSTRACT

An image cutter, a utility model, for producing stereo relief image, is comprised of a base and a blade. The blade is fabricated into a shape that is the same as a designed image, and is positioned on the base. Inside the inner surface of blade, there exit some protruding or dented elements in accordance with the image design. With respect to the base, there is a counter mould also provided with corresponding dented or protruding elements on its surface in order to couple with the base correctly. By employing this image cutter, people can create a stereo, vivid and strong impressive 3D image, similar to a relief, with a better decorative result, a better-visualized effect and a much facile means for children to improve their perceptive as well as distinctive capabilities.

### FIELD OF THE INVENTION

This new utility model relates to a cutting device for images, more particularly to an image cutter.

### DESCRIPTION OF THE PRIOR ARTS

Traditionally, paper-cut artwork is a popular, diverse and highly enjoyable art for many persons, especially for children in early-stage studies. Outside China, many countries have employed this kind of art for their children's learning. For example, in Unite States, people usually apply paper sheet, plastic, rubber or similar materials to cut into letters, cartoons, animals or human beings to train babies in perception and distinction. However, traditional handmade image production is always lower in efficiency and poorer in coincidence without the ability for large scale. In order to overcome such deficiency, people invented a new method for mass production by creating an image cutter at first, the bent the thin and sharp blade into an image shape and fixed it onto a piece of board. They use such tool to cut paper or some other sheet materials repeatedly to produce same images. If they want to fabricate product with a different image, just change to another cutter instead, as P.R China Utility PATENT NO. 01209608.3 disclosed. Although this type of image cutter can obtain large amount of products, it inherits unfavorable defect: the paper image can only be a flat one, no third dimension, without any feelings of lifelikeness or depth.

### SUMMARY OF THE INVENTION

It is, therefore, the objective of this invention to provide an improved simple and reasonable image cutter to overcome such imperfectness derived from contemporary technologies in order to create a stereo, vivid and strong impressive 3D image.

This objective is achieved by following technique: this image cutter is comprised of a base and a blade, with the blade positioned on the base and fabricated into a shape as the designed image, wherein: inside the inner surface of blade, there exit some protruding or dented elements in accordance with the image design and, with respect to the base, there is a counter mould provided with corresponding dented or protruding elements on its surface in order to couple with the base.

The said protruding or dented elements and the base are connected as an integrated structure through casting and pressing. They can also be manufactured separately and joined together by binding, wedging or welding. Surface of said base can be coated with chromosome to enhance blade hardness and cleanness so that lift-time of the cutter can be extended.

The said corresponding dented or protruding elements and the said counter mould are connected as an integrated structure through casting and pressing (for metal materials) or extruding (for plastic materials) technique. However, they can also be manufactured separately and joined together by binding, wedging or welding.

Around the said counter mold, there is a securing borderline whose size fits the base accordingly for catching the base in right position, so as to insure precise coupling between the base and its counter mold and, at the same time, to avoid damage to the base blade due to conflicting movement by above two parts after coupling.

Surface contour of the said base and counter mould can be in plane or in curve.

Embodiment of the invention: firstly, lay a piece of paper (or other sheet materials) on a flat plane; place the cutter above upon it with blade against the paper; press hard. An outline of an image in blade shape is cut out subsequently (now the paper image is still held in the blade). Then, couple the counter mould to the surface of blade of base with the paper image in between; press hard, and finally separate the counter mould from the base. The paper image inside is thus pressed by the protruding or dented elements to become a relief-like image. Basically, the paper can be substituted with other sheet materials and the result is the same.

Comparing with contemporary technology, the invention possesses following advantages and impressions: with this image cutter, people can create a stereo, vivid and strong impressive 3D image, similar to a relief, with a better decorative result, a better-visualized effect and a much facile means for children to improve their perceptive as well as distinctive capabilities.

### BRIEF DESCRIPTION OF THE DRAWINGS

FIG. 1 is a sketch showing the structure of the base.

FIG. 2 is a sketch showing the structure of the counter mould, used for the base illustrated in FIG. 1.

FIG. 3 is a sketch showing the finished product created by the invention.

### DETAILED DESCRIPTION OF THE EMBODIMENT

Following is a detailed description about the invention based on an example with drawings. The embodiment of the invention is not restricted to this example.

### EXAMPLE 1

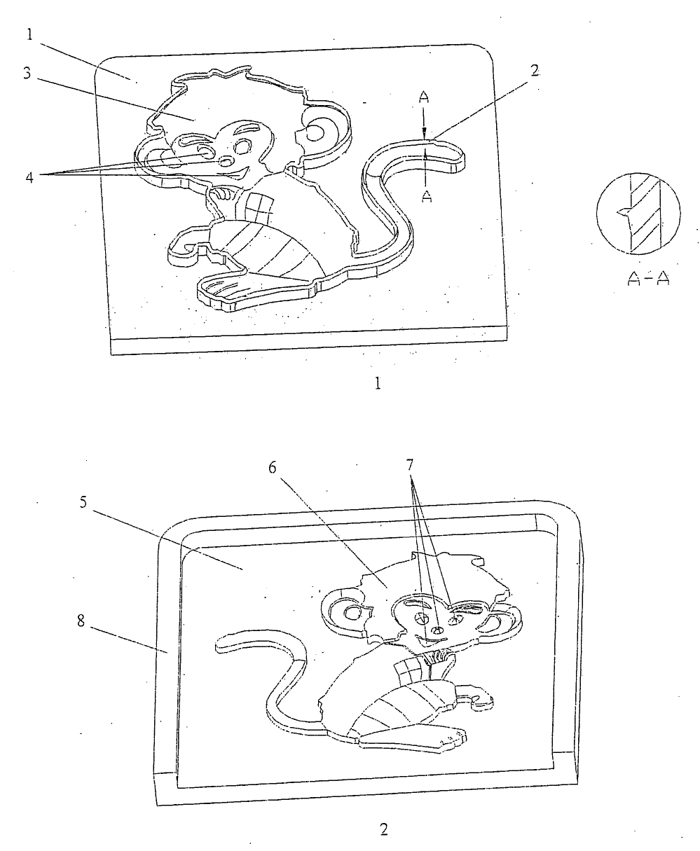

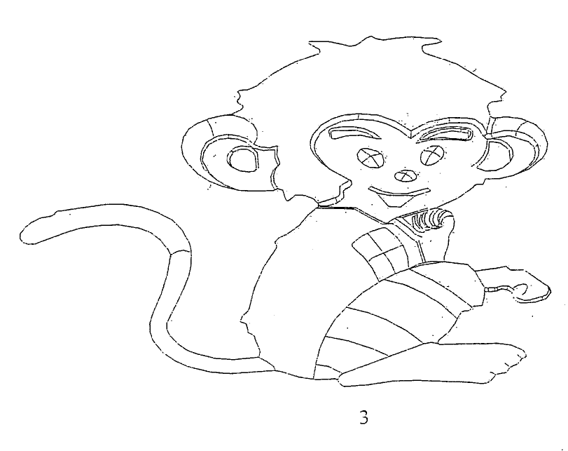

FIGS. 1˜2 illustrate the basic structure of the invention. From FIG. 1, one can see the image cutter is comprised of a base 1 and a blade 2. The blade 2 is positioned on base 1, where the blade 2 is made into a shape of a monkey. Inside the surface of blade 2 of the base 1 in monkey image, there exit some protruding or dented elements 4 to represent, i.e., monkey's eyes, nose or mouth etc. With respect to the base 1, there is a counter mould 5 provided, whose structure is illustrated in FIG. 2. From FIG. 2, one can see there exit some corresponding dented or protruding elements 7 on the surface 6 of counter mould 5 so that the mould 5 can exactly match the base 1. (If the element in base 1 is protruding, the corresponding element in counter mould 5 is dented and vice versa). Around the counter mold 5, there is a securing borderline 8 for catching base 1 in right position, so as to insure precise coupling between the base 1 and its counter mold 5 and, at the same time, to avoid damage to blade 2 of base 1 due to conflicting movement by above two parts after coupling. Material for the said base is made of alloys (i.e. zinc or aluminum alloy) and the connection between said protruding or dented elements 4 and base 1 can be an integrated structure through casting and pressing technique; while material for counter mold is made of plastics (i.e. ABS or PP) and the connection between said corresponding dented or protruding elements 7 and counter mold 5 can be an integrated structure through extruding technique.

Embodiment: lay a piece of paper on a flat PP board (or ABS, PMMA or others no harm to the blade); place base 1 upon it with blade 2 against the paper; press hard and the blade 2 of base 1 will cut the paper into a shape with monkey outline. The paper now is still held by blade 2. Then couple the counter mold 5 to the surface of blade 2 of base 1 with the paper image in between the mold 5 and base 1; press hard; and finally separate the counter mold 5 from the base 1. The paper image inside is thus pressed by the protruding or dented elements 4 in base 1 and their corresponding dented or protruding elements 7 in counter mold 5. So, monkey's eyes, nose and mouth are consequently emerged. As a result, people can obtain a relief-like paper art of a monkey image.

1. An image cutter for producing stereo relief image, comprising a base and a blade, with the blade positioned on the base and fabricated into a shape as a designed image, wherein: inside the inner surface of blade, there exit some protruding or dented elements in accordance with the image design and, with respect to the base, there is a counter mould provided with corresponding dented or protruding elements on its surface in order to couple with the base.

2. An image cutter for producing stereo relief image according to claim 1, wherein: the said dented or protruding elements and the base are connected as an integrated structure.

3. An image cutter for producing stereo relief image according to claim 1, wherein: the said dented or protruding elements and the said base are two separate parts, which can be joined together by binding, wedging or welding.

4. An image cutter for producing stereo relief image according to claim 1, wherein: the said corresponding dented or protruding elements and the said counter mould are two separate parts, which can be joined together by binding, wedging or welding.

5. An image cutter for producing stereo relief image according to claim 1, wherein: the said corresponding dented or protruding elements and the said counter mould are connected as an integrated structure.

6. An image cutter for producing stereo relief image according to claim 1, wherein: around the said counter mould, there is a securing borderline whose size fits the base accordingly.

7. An image cutter for producing stereo relief image according to claim 1, wherein: the said base and the counter mould have the same surface contour, no matter what in plane or in curve.
